(19) United States
(12) Patent Application Publication
(10) Pub. No.: US 2015/0222630 A1
(43) Pub. Date: Aug. 6, 2015

(54) THIRD APPLICATION LOGIN METHOD AND CORRESPONDING APPARATUS AND TERMINAL

(71) Applicant: TENCENT TECHNOLOGY (SHENZHEN) COMPANY LIMITED, Shenzhen (CN)

(72) Inventor: Wenbin He, Shenzhen (CN)

(73) Assignee: TENCENT TECHNOLOGY (SHENZHEN) COMPANY LIMITED, Shenzhen (CN)

(21) Appl. No.: 14/685,727

(22) Filed: Apr. 14, 2015

Related U.S. Application Data
(63) Continuation of application No. PCT/CN2014/077063, filed on May 8, 2014.

(30) Foreign Application Priority Data
May 21, 2013 (CN) 201310190467.2

(51) Int. Cl. H04L 29/06; H04W 12/06; G10L 17/22; H04L 29/08

(52) U.S. Cl. CPC H04L 63/0861; H04L 67/10; H04W 12/06; G10L 17/22

(57) ABSTRACT

Described relates to mobile Internet field, and described are a third application login method, a third application login apparatus and a third application login terminal. The third application login method includes: obtaining biologic feature information of a user; authenticating the biologic feature information of the user, when the biologic feature information passes authentication, reminding the user the third application is allowed to use; detecting a trigger instruction generated according to a user's response to a reminder and input by any third application; responding to the trigger instruction, sending an information obtaining request to a cloud server; the information obtaining request being configured to obtain a personal account of the third application, and receive the personal account of the third application sent from the cloud server; and logging in the third application with the personal account of the third application.

### CROSS-REFERENCE TO RELATED APPLICATIONS

This is a U.S. continuation application under 35 U.S.C. §111(a) claiming priority under 35 U.S.C. §§120 and 365(c) to International Application No. PCT/CN2014/077063 filed on May 8, 2014, which claims the priority benefit of Chinese Patent Application NO. 201310190467.2 filed on May 21, 2013, the contents of which are incorporated by reference herein in their entirety for all intended purposes.

### FIELD OF THE TECHNICAL

The present disclosure relates to mobile Internet field, and more particularly, to a third application login method, and corresponding apparatus and terminal.

### BACKGROUND

With a development of mobile Internet, mobile apparatuses (such as, mobile phones) can use a lot of third applications. The third applications also short for APP. For example, the third application may be microblog, personal space, game, digital reading, etc. Usually, a user needs a personal account to login the third application on the mobile apparatus. Different third applications may be corresponding to different personal accounts. Obviously, with an increase of the third applications, the personal accounts corresponding to the third applications also increase. It is inconvenient for the user to remember all of the personal accounts. When the user does not login a third application, the user may forget the personal account corresponding to the third application. A success rate of login the third application is reduced.

### SUMMARY

The embodiments of present disclosure provide a third application login method, and corresponding apparatus and terminal. The user can login a third application without recording a personal account of the third application. Thus, a success rate of logging in the third application is improved.

According to a first aspect of present disclosure, a third application login method is provided. The third application login method includes:

obtaining biologic feature information of a user;

authenticating the biologic feature information of the user, when the biologic feature information passes authentication, reminding the user a third application is allowed to use;

detecting a trigger instruction generated according to a user's response to a reminder and input by any third application;

responding to the trigger instruction, sending an information obtaining request to a cloud server; the information obtaining request being configured to obtain a personal account of the third application, and receive the personal account of the third application sent from the cloud server; and

logging in the third application with the personal account of the third application.

According to a second aspect of present disclosure, a third application apparatus is provided. The third apparatus includes:

an obtaining module, configured to obtain biologic feature information of a user;

an authenticating and prompting module, configured to authenticate the biologic feature information of the user obtained by the obtaining module, when the biologic feature information passes an authentication, the authenticating and prompting module further configured to remind the user the third application is allowed to use.

a detecting module, configured to detect a rigger instruction generated according to a user's response to a reminder input by any third application via the authenticating and prompting module;

a receiving and sending module, configured to respond to the trigger instruction detected by the detecting module, and send an information obtaining request to a cloud server, the information obtaining request being configured to obtain a personal account of the third application, and receive the personal account of the third application sent from the cloud server; and

a logging in module, configured to login the third application with the personal account of the third application received by the receiving and sending module.

According to a third aspect of present disclosure, a third application login terminal is provided. The terminal includes a third application login apparatus of the second aspect of present disclosure.

In the embodiments of present disclosure, after the terminal obtains the biologic feature information of the user, if the biologic feature information passes the authentication, the terminal reminds the user the third application is allowed to use. When the terminal detecting the trigger instruction generated according to a reminder, the terminal sends the information obtaining request to the cloud server. Herein, the reminder is generated by the user responding to any one of the third application and input by the third application. The information obtaining request is configured to obtain a personal account of the third application. When receiving the personal account corresponding to the personal account sent from the cloud server, the terminal logins the third application with the personal account corresponding to the personal account. The user can conveniently login the third application without recording the personal account of the third application. Even if the user forgets the personal account of some third application, the user can also login the third application. Thus, a success rate of logging in the third application is improved.

### BRIEF DESCRIPTION OF THE DRAWINGS

In order to make the embodiment of present disclosure or the embodiment of prior art more clearly, the drawings which are needed in the embodiment of present disclosure or the embodiment of prior art are described simply as follows. It is obviously, the drawings described as the follows are only exemplary embodiments of present disclosure. To a person of ordinary skill in the art, under premise of no creative work, other drawings may be obtained according to the drawings.

FIG. 1 is a flowchart of a third application login method according to one embodiment of present disclosure.

FIG. 2 is a display interface for a third application of a terminal according to one embodiment of present disclosure.

FIG. 3 is a flowchart of a third application login method according to another embodiment of present disclosure.

FIG. 4 is a flowchart of a third application login method according to yet another embodiment of present disclosure.

FIG. 5 is a schematic diagram of a third application apparatus according to one embodiment of present disclosure.

FIG. 6 is a schematic diagram of a terminal according to one embodiment of present disclosure.

### DETAILED DESCRIPTION OF ILLUSTRATED EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

A third application login method, and corresponding apparatus and terminal are provided in embodiments of present disclosure. The user can conveniently login a third application without recording a personal account of the third application. Thus, a success rate of logging in the third application is improved. Illustration is described in detail as follows.

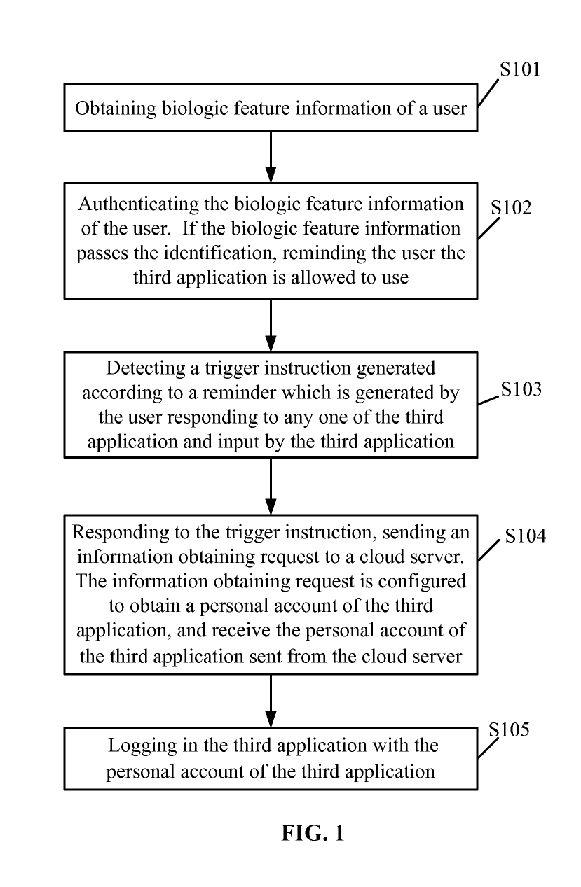

Referring to FIG. 1, FIG. 1 is a flowchart of a third application login method according to one embodiment of present disclosure. The third application login method is applied to a terminal. The terminal may be but not limited to smart phone, panel computer, personal computer (PC), mobile Internet device (MID). The third application login method includes the following steps.

Step S101, obtaining biologic feature information of a user.

In the embodiment of present disclosure, the terminal is stored with an authenticating application. Thus the terminal can obtain the biologic feature information of the user via the authenticating application.

In the embodiment of present disclosure, the biologic feather information of the user can include but not limit to figureprint recognition information, facial recognition information, voice recognition information, etc. In another word, the terminal obtains the figureprint recognition information, facial recognition information, voice recognition information via the authenticating application.

Step S102, authenticating the biologic feature information of the user. If the biologic feature information passes the identification, reminding the user the third application is allowed to use.

In the embodiment of present disclosure, the terminal authenticates the biologic feature information of the user via the authenticating application. If the biologic feature information passes the authentication, the terminal reminds the user the third application is allowed to use; otherwise, if the biologic feature information does not pass the authentication, the third terminal reminds the user the third application is not allowed to use.

In an example, the authenticating application obtains the figureprint recognition information of the user. The terminal compares the figureprint recognition information of the user with pre-stored figureprint recognition information. If the figureprint recognition information of the user matches with the pre-stored figureprint recognition information, the terminal reminds the user the third application is allowed to use; otherwise, the terminal reminds the user the third application is not allowed to use.

In another example, the authenticating application obtains facial recognition information. The terminal compares the facial recognition information with pre-stored facial recognition information. If the facial recognition information matches with the pre-stored facial recognition information, the third terminal reminds the user the third application is allowed to use; otherwise, the terminal reminds the user the third application is not allowed to use.

In yet another example, the authenticating application obtains voice recognition information. The terminal compares the voice recognition information with pre-stored voice recognition information. If the voice recognition information matches with the pre-stored voice recognition information, the third terminal reminds the user the third application is allowed to use; otherwise, the terminal reminds the user the third application is not allowed to use.

In the embodiments of present disclosure, the third application can include connecting application, such as, e-mail, instant message (IM), global positioning system (GPS) navigation, remote access, etc. The third application can include commercial application, such as, mobile banking, stock tracking and dealing, document handing, schedule planning, etc. The third application can include living application, such as, electronic commerce, bill payment, health monitoring, digital reading, and social contact, etc. The third application can include entertainment application, such as, news, game, multimedia player, photo and video editor, etc. It is understood that the third application is not limited to the above examples.

In the embodiments of present disclosure, the terminal can remind the user the third application is allowed to use by a textual mode and/or a voice mode. It is understood, the embodiments of present disclosure is not limited to the textual mode and/or the voice mode.

Step S103, detecting a trigger instruction generated according to a reminder which is generated by the user responding to any one of the third application and input by the third application.

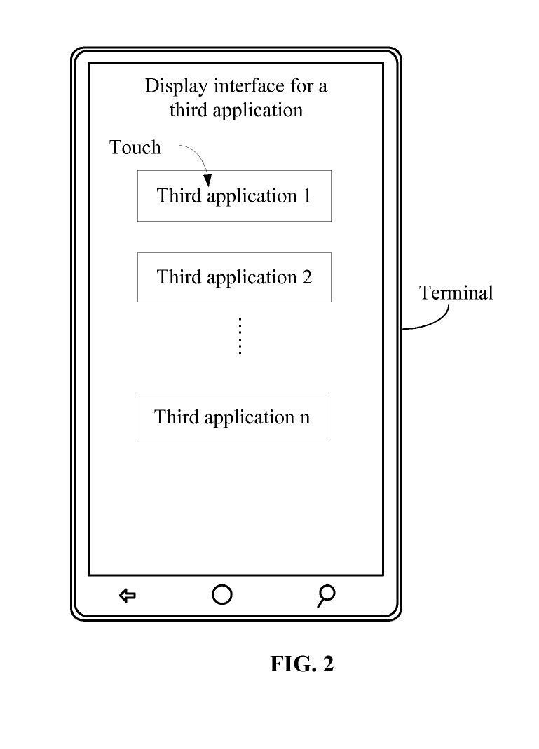

Referring to FIG. 2, FIG. 2 is a display interface for a third application of a terminal according to one embodiment of present disclosure. The display interface displays n third applications (from application 1 to application n). The terminal detects the trigger instruction input by any third application of the n third applications. The trigger instruction is generated according to a user's response to a reminder. In the embodiment, the trigger instruction can be but not limited to a signal click, a double click, sliding.

Step S104, responding to the trigger instruction, sending an information obtaining request to a cloud server. The information obtaining request is configured to obtain a personal account of the third application, and receive the personal account of the third application sent from the cloud server.

In the embodiment of present disclosure, the personal account usually includes but not limit to a user name and a password.

In the embodiment of present disclosure, the terminal responds to the trigger instruction, sends the information obtaining request to the cloud server. The information obtaining request includes an identification of the third application. Correspondingly, the cloud server stores a mapping relationship between the identification of the third application and the personal account of the third application. When the cloud server receives the information obtaining request with the identification of the third application, the cloud server searches the personal account of the third application corresponding to the identification of the third application according to the mapping relationship. Then the cloud server sends the personal account of the third application to the terminal. By the method described above, a management of the third terminal which is login by a unique user is realized.

In the embodiment of present disclosure, the terminal responds to the trigger instruction, sends the information obtaining request to the cloud server. The information obtaining request includes the identification of the third application and the biologic feature information of the user. Correspondingly, the cloud server stores a mapping relationship among the biologic feature information of the user, the identification of the third application, and the personal account of the third application. When the cloud server receives the information obtaining request with the identification of the third application and the biologic feature information of the user, the cloud server searches the personal account of the third application corresponding to the identification of the third application and the biologic feature information of the user according to the mapping relationship. Then the cloud server sends the personal account of the third application to the terminal. By the method described above, a management of the third terminal which is login by different user is realized.

Step 105, logging in the third application with the personal account of the third application.

In the embodiment of present disclosure, when the terminal receives the personal account of the third application sent from the cloud server, the terminal logins the third application with the personal account. The user can make operation to the third application. The operation to the third application can be sharing, rebroadcasting, commenting, praising, recommending, pushing up, comment, collecting, scoring, and downloading.

In the method described in FIG. 1, when the terminal obtains the biologic feature information of the user, if the biologic feature information passes the authentication, the terminal reminds the user the third application is allowed to use. When the terminal detecting the trigger instruction generated according to a user's response to a reminder and input by any third application, the terminal sends the information obtaining request to the cloud server. The information obtaining request is configured to obtain a personal account of the third application. When receiving the personal account sent from the cloud server, the terminal logins the third application with the personal account. From the method described in FIG. 1, the user can conveniently login the third application without recording the personal account of the third application. Even if the user forgets the personal account of some third application, the user can also login the third application. Thus, a success rate of logging in the third application is improved.

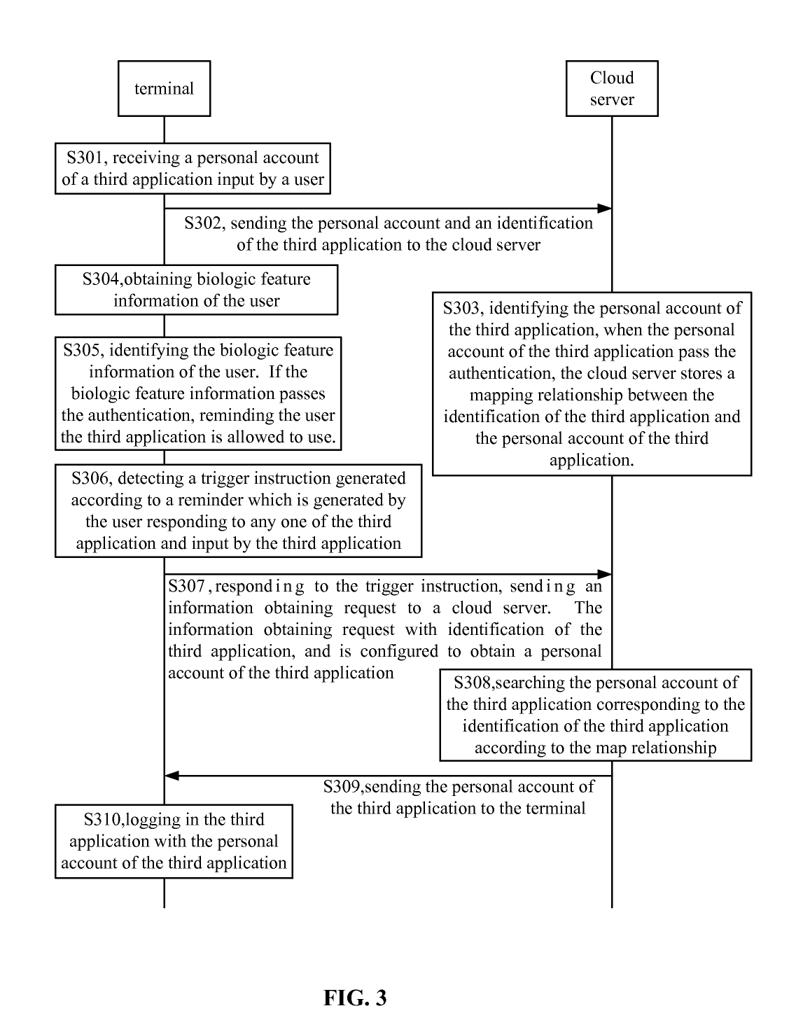

Referring to FIG. 3, FIG. 3 is a flowchart of a third application login method according to another embodiment of present disclosure. The third application login method is applied to a terminal. The terminal may be but not limited to smart phone, panel computer, personal computer (PC), mobile Internet device (MID). The third application login method includes the following steps.

Step S301, a terminal receives a personal account of a third application input by a user.

In the embodiment of present disclosure, the terminal obtains the personal account of the third application via an authenticating application.

Referring to FIG. 2 again, the display displays n third applications. The n third applications are from application 1 to application n. The terminal receives the personal account of the application 1 to the personal account of the application n via the authenticating application. In an example, the user can input the personal account of the application 1 to the personal account of the application n in batch via the authenticating application. In another example, the user can input the personal account of the application 1 to the personal account of the application n in one time via the authenticating application. It is understood that the embodiment is not limited to the above two examples.

Step S302, the terminal sends the personal account and an identification of the third application to the cloud server.

In the embodiment of present disclosure, the terminal encrypt the personal account and an identification of the third application, and sends the personal account and an identification of the third application which are encrypted to the cloud server.

Step S303, the cloud server authenticates the personal account of the third application, when the personal account of the third application pass the authentication, the cloud server stores a mapping relationship between the identification of the third application and the personal account of the third application.

In an example, the mapping relationship between the identification of the third application and the personal account of the third application can be shown in table 1.

TABLE 1

| Identification | Personal account |
|---|---|
| Identification of the | Personal account of the |
| third application 1 | third application 1 |
| . | . |
| . | . |
| . | . |
| Identification of the | Personal account of the |
| third application n | third application n |

If the personal account does not pass the authentication, the cloud server does not need to store the mapping relationship between the identification of the third application and the personal account of the third application.

Step S304, the terminal obtains biologic feature information of the user.

In the embodiment of present disclosure, the terminal obtains the biologic feature information of the user via the authenticating application.

In the embodiment of present disclosure, the biologic feather information of the user can include but not limit to figureprint recognition information, facial recognition information, voice recognition information, etc. In another word, the terminal obtains the figureprint recognition information, facial recognition information, voice recognition information via the authenticating application.

Step S305, the terminal authenticates the biologic feature information of the user. If the biologic feature information passes the authentication, reminding the user the third application is allowed to use.

In the embodiment of present disclosure, the terminal authenticates the biologic feature information of the user via the authenticating application. If the biologic feature information passes the authentication, the terminal reminds the user the third application is allowed to use; otherwise, if the biologic feature information does not pass the authentication, the third terminal reminds the user the third application is not allowed to use.

In an example, the authenticating application obtains the figureprint recognition information of the user. The terminal compares the figureprint recognition information of the user with pre-stored figureprint recognition information, if the figureprint recognition information of the user matches with pre-stored figureprint recognition information, the terminal reminds the user the third application is allowed to use; otherwise, the terminal reminds the user the third application is not allowed to use.

In another example, the authenticating application obtains the facial recognition information. The terminal compares the facial recognition information with pre-stored facial recognition information, if the facial recognition information matches with the pre-stored facial recognition information, the third terminal reminds the user the third application is allowed to use; otherwise, the terminal reminds the user the third application is not allowed to use.

In yet another example, the authenticating application obtains the voice recognition information. The terminal compares the voice recognition information with pre-stored voice recognition information, if the voice recognition information matches with the pre-stored voice recognition information, the third terminal reminds the user the third application is allowed to use; otherwise, the terminal reminds the user the third application is not allowed to use.

In the embodiments of present disclosure, the third application can include connecting application, such as, e-mail, instant message (IM), global positioning system (GPS) navigation, remote access, etc. The third application can include commercial application, such as, mobile banking, stock tracking and dealing, document handing, schedule planning, etc. The third application can include living application, such as, electronic commerce, bill payment, health monitoring, digital reading, and social contact, etc. The third application can include entertainment application, such as, news, game, medium player, photo and video editor, etc. It is understood that the third application is not limited to the above examples.

In the embodiments of present disclosure, the terminal can remind the user the third application is allowed to use by a textual mode and/or a voice mode. It is understood, the embodiments of present disclosure is not limited to the textual mode and/or the voice mode.

Step S306, the terminal detects a trigger instruction generated according to a reminder which is generated by the user responding to any one of the third application and input by the third application.

Referring to FIG. 2, FIG. 2 is a display interface for a third application of a terminal according to one embodiment of present disclosure. The display interface displays n third applications (from application 1 to application n). The terminal detects the trigger instruction input by any third application of the n third applications. The trigger instruction is generated according to a user's response to a reminder. In the embodiment, the trigger instruction can be but not limited to a signal click, a double click, sliding.

Step S307, the terminal responds to the trigger instruction, and sends an information obtaining request to a cloud server. The information obtaining request with identification of the third application, and is configured to obtain a personal account of the third application.

Step S308, the cloud server searches the personal account of the third application corresponding to the identification of the third application according to the mapping relationship.

For example, the cloud server searches the personal account of the third application 1 corresponding to the identification of the third application 1 according to the mapping relationship stored in the table 1.

Step S309, the cloud server sends the personal account of the third application to the terminal.

In the embodiment of present disclosure, the personal account usually includes but not limit to a user name and a password.

Step S310, the terminal logins the third application with the personal account of the third application.

In the embodiment of present disclosure, when the terminal receives the personal account of the third application sent from the cloud server, the terminal logins the third application with the personal account. The user can make operation to the third application. The operation to the third application can be sharing, rebroadcasting, commenting, praising, recommending, pushing up, stamping, collecting, scoring, and downloading.

In the method described in FIG. 3, when the terminal receives the personal account of the third application, the terminal sends the personal account of the third application and the identification of the third application to the cloud server. When the personal account of the third application passes the authentication, the cloud server stores the mapping relationship between the personal account of the third application and the identification of the third application. When the terminal obtains the biologic feature information of the user, if the biologic feature information of the user passes the authentication, the terminal reminds the user the third application is allowed to use. When the terminal detecting the trigger instruction generated according to a user's response to a reminder and input by any third application, the terminal sends the information obtaining request to the cloud server. The information obtaining request is configured to obtain a personal account of the third application. When receiving the personal account sent from the cloud server, the terminal logins the third application with the personal account. From the method described in FIG. 3, the user can conveniently login the third application without recording the personal account of the third application. Even if the user forgets the personal account of some third application, the user can also login the third application. Thus, a success rate of logging in the third application is improved.

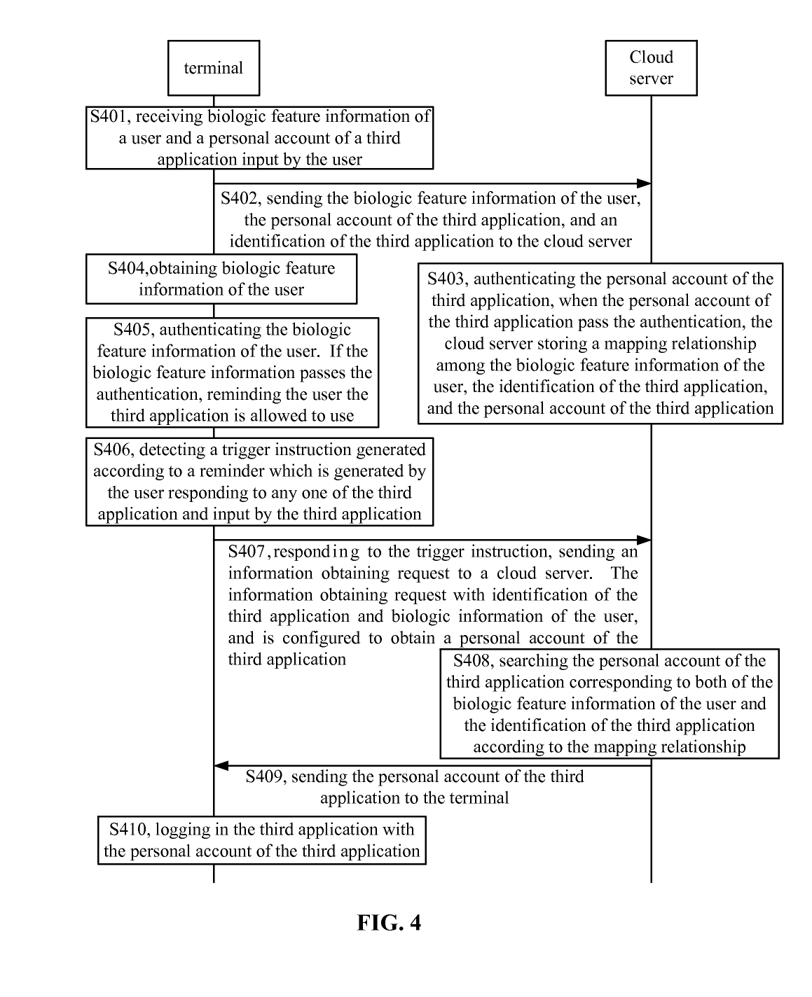

Referring to FIG. 4, FIG. 4 is a flowchart of a third application login method according to yet another embodiment of present disclosure. The third application login method is applied to a terminal. The terminal may be but not limited to smart phone, panel computer, personal computer (PC), mobile Internet device (MID). The third application login method includes the following steps.

Step S401, a terminal receives biologic feature information of a user and a personal account of a third application input by the user.

In the embodiment of present disclosure, the terminal receives the biologic feature information of the user and the personal account of the third application via an authenticating application.

Referring to FIG. 2 again, the display displays n third applications. The n third applications are from application 1 to application n. The terminal receives the biologic feature information of the user, and the personal account of the application 1 to the personal account of the application n via the authenticating application. In an example, the user can input the biologic feature information of the user, and the personal account of the application 1 to the personal account of the application n in batch via the authenticating application. In another example, the user can input the biologic feature information of the user, and the personal account of the application 1 to the personal account of the application n in one time via the authenticating application. It is understood that the embodiment is not limited to the above two examples.

Step S402, the terminal sends the biologic feature information of the user, the personal account of the third application, and an identification of the third application to the cloud server.

In the embodiment of present disclosure, the terminal encrypt the biologic feature information of the user, the personal account, and an identification of the third application. Then the terminal sends the biologic feature information of the user, the personal account, and an identification of the third application which are encrypted to the cloud server.

Step S403, the cloud server authenticates the personal account of the third application, when the personal account of the third application pass the authentication, the cloud server stores a mapping relationship among the biologic feature information of the user, the identification of the third application, and the personal account of the third application.

In an example, the mapping relationship among the biologic feature information of the user, the identification of the third application, and the personal account of the third application can be shown in table 2.

TABLE 2

| User | Identification | Personal account |
|---|---|---|
| Biologic feature | Identification of the | Personal account of the |
| information 1 | third application 1 | third application 1 |
| . | . | . |
| . | . | . |
| . | . | . |
| Biologic feature | Identification of the | Personal account of the |
| information 1 | third application n | third application n |
| Biologic feature | Identification of the | Personal account of the |
| information 2 | third application 1 | third application 1 |
| . | . | . |
| . | . | . |
| . | . | . |
| Biologic feature | Identification of the | Personal account of the |
| information 2 | third application n | third application n |

It can be seen from the table 2, different biologic feature information of the user may be corresponds to the same identification of the third application, but different biologic feature information of the user corresponds to different personal accounts.

If the personal account does not pass the authentication, the cloud server does not need to store the mapping relationship among the biologic feature information of the user, the identification of the third application, and the personal account of the third application.

Step S404, the terminal obtains biologic feature information of the user.

In the embodiment of present disclosure, the terminal obtains the biologic feature information of the user via the authenticating application.

In the embodiment of present disclosure, the biologic feather information of the user can include but not limit to figureprint recognition information, facial recognition information, voice recognition information, etc. In another word, the terminal obtains the figureprint recognition information, facial recognition information, voice recognition information via the authenticating application.

Step S405, the terminal authenticates the biologic feature information of the user. If the biologic feature information passes the authentication, reminding the user the third application is allowed to use.

In the embodiment of present disclosure, the terminal authenticates the biologic feature information of the user via the authenticating application. If the biologic feature information passes the authentication, the terminal reminds the user the third application is allowed to use; otherwise, if the biologic feature information does not pass the authentication, the third terminal reminds the user the third application is not allowed to use.

In an example, the authenticating application obtains the figureprint recognition information of the user. The terminal compares the figureprint recognition information of the user with pre-stored figureprint recognition information, if the figureprint recognition information of the user matches with pre-stored figureprint recognition information, the terminal reminds the user the third application is allowed to use; otherwise, the terminal reminds the user the third application is not allowed to use.

In another example, the authenticating application obtains the facial recognition information. The terminal compares the facial recognition information with pre-stored facial recognition information, if the facial recognition information matches with the pre-stored facial recognition information, the third terminal reminds the user the third application is allowed to use; otherwise, the terminal reminds the user the third application is not allowed to use.

In yet another example, the authenticating application obtains the voice recognition information. The terminal compares the voice recognition information with pre-stored voice recognition information, if the voice recognition information matches with the pre-stored voice recognition information, the third terminal reminds the user the third application is allowed to use; otherwise, the terminal reminds the user the third application is not allowed to use.

In the embodiments of present disclosure, the third application can include connecting application, such as, e-mail, instant message (IM), global positioning system (GPS) navigation, remote access, etc. The third application can include commercial application, such as, mobile banking, stock tracking and dealing, document handing, schedule planning, etc. The third application can include living application, such as, electronic commerce, bill payment, health monitoring, digital reading, and social contact, etc. The third application can include entertainment application, such as, news, game, medium player, photo and video editor, etc. It is understood that the third application is not limited to the above examples.

In the embodiments of present disclosure, the terminal can remind the user the third application is allowed to use by a textual mode and/or a voice mode. It is understood, the embodiments of present disclosure is not limited to the textual mode and/or the voice mode.

Step S406, the terminal detects a trigger instruction generated according to a reminder which is generated by the user responding to any one of the third application and input by the third application.

Referring to FIG. 2, FIG. 2 is a display interface for a third application of a terminal according to one embodiment of present disclosure. The display interface displays n third applications (from application 1 to application n). The terminal detects the trigger instruction input by any third application of the n third applications. The trigger instruction is generated according to a user's response to a reminder. In the embodiment, the trigger instruction can be but not limited to a signal click, a double click, sliding.

Step S407, the terminal responds to the trigger instruction, sending an information obtaining request to a cloud server. The information obtaining request with identification of the third application and biologic information of the user, and is configured to obtain a personal account of the third application.

Step S408, the cloud server searches the personal account of the third application corresponding to both of the biologic feature information of the user and the identification of the third application according to the mapping relationship.

For example, the cloud server searches the personal account of the third application 1 corresponding to both of the biologic feature information 1 of the user and the identification 1 of the third application according to the mapping relationship stored in the table 2.

Step S409, the cloud server sends the personal account of the third application to the terminal.

In the embodiment of present disclosure, the personal account usually includes but not limit to a user name and a password.

Step S410, the terminal logins the third application with the personal account of the third application.

In the embodiment of present disclosure, when the terminal receives the personal account of the third application sent from the cloud server, the terminal logins the third application with the personal account. The user can make operation to the third application. The operation to the third application can be sharing, rebroadcasting, commenting, praising, recommending, pushing up, stamping, collecting, scoring, and downloading.

In the method described in FIG. 4, when the terminal receives the biologic feature information of the user and the personal account of the third application, the terminal sends biologic feature information of the user, the personal account of the third application, and the identification of the third application to the cloud server. When the personal account of the third application passes the authentication, the cloud server stores the mapping relationship among the biologic feature information of the user, the identification of the third application, and the personal account of the third application. When the terminal obtains the biologic feature information of the user, if the biologic feature information of the user passes the authentication, the terminal reminds the user the third application is allowed to use. When the terminal detecting the trigger instruction generated according to a user's response to a reminder and input by any third application, the terminal sends the information obtaining request to the cloud server. The information obtaining request is configured to obtain a personal account of the third application. When receiving the personal account sent from the cloud server, the terminal logins the third application with the personal account. From the method described in FIG. 4, the user can conveniently login the third application without recording the personal account of the third application. Even if the user forgets the personal account of some third application, the user can also login the third application. Thus, a success rate of logging in the third application is improved.

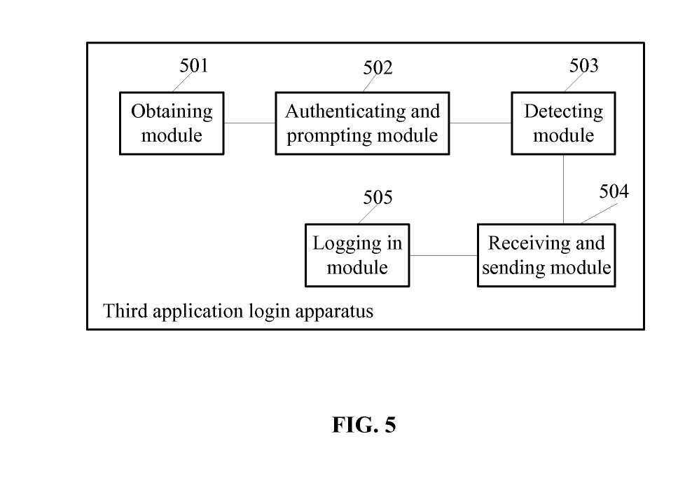

Referring to FIG. 5, FIG. 5 is a schematic diagram of a third application apparatus according to one embodiment of present disclosure. The third application apparatus is applied to a terminal. The terminal may be but not limited to smart phone, panel computer, personal computer (PC), mobile Internet device (MID). The third application apparatus includes the following modules.

An obtaining module 501, which is configured to obtain biologic feature information of a user.

An authenticating and prompting module 502, which is configured to authenticating the biologic feature information of the user obtained by the obtaining module 501. If the biologic feature information passes the authentication, the authenticating and prompting module 502 reminds the user the third application is allowed to use.

A detecting module 503, which is configured to detect a rigger instruction generated according to a user's response to a reminder input by any third application via the authenticating and prompting module 502.

A receiving and sending module 504, which is configured to respond to the trigger instruction detected by the detecting module 503, and send an information obtaining request to a cloud server. The information obtaining request is configured to obtain a personal account of the third application, and receive the personal account of the third application sent from the cloud server.

A logging in module 505, which is configured to login the third application with the personal account of the third application received by the receiving and sending module 504.

In an embodiment of present disclosure, the information obtaining request which is sent from the receiving and sending module 504 to the cloud server carries with the identification of the third application. Correspondingly, the receiving and sending module is further configured to receive the personal account of the third application input by the user, and send the personal account of the third application and the identification of the third application to the cloud server. When the personal account of the third application passes the authentication, the receiving and sending module 504 stores a mapping relationship between the identification of the third application and the personal account of the third application. In this way, a management of the third terminal which is login by a unique user is realized.

In another embodiment of present disclosure, the information obtaining request which is sent from the receiving and sending module 504 to the cloud server carries with the identification of the third application and the biologic feature information of the user. Correspondingly, the receiving and sending module 504 is further configured to receive the biologic feature information and the personal account input by the user, send the biologic feature information of the user, the personal account of the third application, and the identification of the third application to the cloud server. When the personal account of the third application passes the authentication, the receiving and sending module 504 stores a mapping relationship among the biologic information of the user, the identification of the third application, and the personal account of the third application. In this way, a management of the third terminal which is login by different user is realized.

In an embodiment of present disclosure, the obtaining module 501 is configured to obtain figureprint recognition information of the user. Correspondingly, the authenticating and prompting module 502 is configured to compare the figureprint recognition information of the user with pre-stored figureprint recognition information. If the figureprint recognition information of the user matches with the pre-stored figureprint recognition information, the authenticating and prompting module 502 reminds the user the third application is allowed to use; otherwise, the authenticating and prompting module 502 reminds the user the third application is not allowed to use.

In another embodiment of present disclosure, the obtaining module 501 is configured to obtain facial recognition information. Correspondingly, the authenticating and prompting module 502 is configured to compare the facial recognition information with pre-stored facial recognition information. If the facial recognition information matches with the pre-stored facial recognition information, the authenticating and prompting module 502 reminds the user the third application is allowed to use; otherwise, the authenticating and prompting module 502 reminds the user the third application is not allowed to use.

In the embodiments of present disclosure, the terminal can remind the user the third application is allowed to use by a textual mode and/or a voice mode. It is understood, the embodiments of present disclosure is not limited to the textual mode and/or the voice mode.

In yet another embodiment of present disclosure, the obtaining module 501 is configured to obtain voice recognition information. Correspondingly, the authenticating and prompting module 502 is configured to compare the voice recognition information with pre-stored voice recognition information. If the voice recognition information matches with the pre-stored voice recognition information, the authenticating and prompting module 502 reminds the user the third application is allowed to use; otherwise, the authenticating and prompting module 502 reminds the user the third application is not allowed to use.

To the third application apparatus described in FIG. 5, the user can login the third application without recording the personal account of the third application. Even if the user forgets the personal account of the third application, the user can also login the third application. Thus, a success rate of logging in the third application is improved.

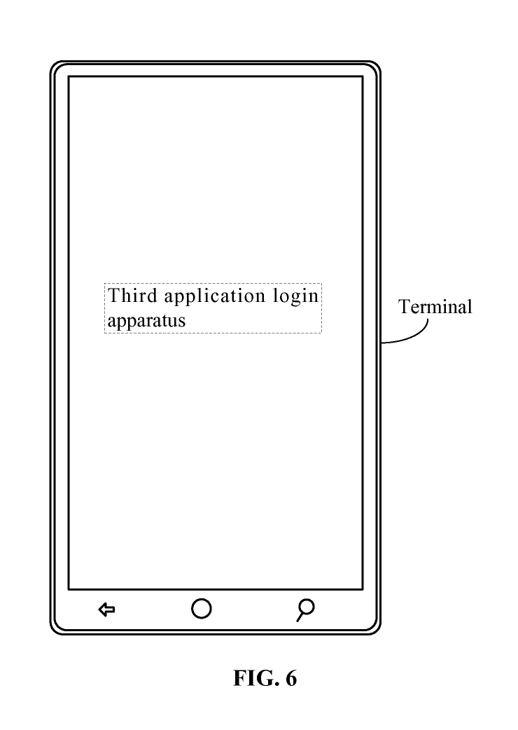

Referring to FIG. 6, FIG. 6 is a schematic diagram of a terminal according to one embodiment of present disclosure. The terminal includes the third application apparatus described in FIG. 5. To the terminal of FIG. 6, the user can login the third application without recording the personal account of the third application. Even if the user forgets the personal account of the third application, the user can also login the third application. Thus, a success rate of logging in the third application is improved.

A person having ordinary skills in the art can realize that part of or all of the processes in the methods according to the above embodiments may be implemented by a computer program instructing relevant hardware. The program may be stored in a computer readable storage medium. When the program is executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of present disclosure, but not intended to limit the protection scope of the present disclosure. Any variation or replacement made by a person of ordinary skills in the art without departing from the spirit of the present disclosure shall fall within the protection scope of the present disclosure. Therefore, the scope of the present disclosure shall be subject to be appended claims.

1. A third application login method, comprising:
obtaining biologic feature information of a user;
authenticating the biologic feature information of the user, when the biologic feature information passes authentication, reminding the user a third application is allowed to use;
detecting a trigger instruction generated according to a reminder which is generated by the user responding to any one of the third application and input by the third application;
responding to the trigger instruction, sending an information obtaining request to a cloud server; the information obtaining request being configured to obtain a personal account of the third application, and receive the personal account of the third application sent from the cloud server; and
logging in the third application with the personal account of the third application.

2. The third application login method according to claim 1, wherein the information obtaining request comprises an identification of the third application.

3. The third application login method according to claim 2, before the step of obtaining biologic feature information of a user, further comprising:
receiving a personal account of the third application input by the user;
sending the personal account and an identification of the third application to the cloud server; when the personal account of the third application passes the authentication of the cloud server, the cloud server storing a mapping relationship between the identification of the third application and the personal account of the third application.

4. The third application login method according to claim 1, wherein the information obtaining request comprises an identification of the third application and the biologic feature information of the user.

5. The third application login method according to claim 4, before the step of obtaining biologic feature information of a user, further comprising:
receiving biologic feature information of the user and a personal account of the third application input by the user;
sending the biologic feature information of the user, the personal account of the third application, and an identification of the third application to the cloud server, when the personal account of the third application passes the authentication of the cloud server, storing a mapping relationship among the biologic feature information of the user, the identification of the third application, and the personal account of the third application.

6. The third application login method according to claim 1, wherein the step of obtaining biologic feature information of a user, comprises:
obtaining figureprint recognition information of the user;
the step of authenticating the biologic feature information of the user, when the biologic feature information passes authentication, reminding the user a third application is allowed to use, comprises:
comparing obtained figureprint recognition information of the user with pre-stored figureprint recognition information, when the figureprint recognition information of the user matches with the pre-stored figureprint recognition information, reminding the user the third application is allowed to use.

7. The third application login method according to claim 1, wherein the step of obtaining biologic feature information of a user, comprises:
obtaining facial recognition information of the user;
the step of authenticating the biologic feature information of the user, when the biologic feature information passes authentication, reminding the user a third application is allowed to use, comprises:
comparing the obtained facial recognition information with pre-stored facial recognition information, when the facial recognition information matches with the pre-stored facial recognition information, reminding the user the third application is allowed to use.

8. The third application login method according to claim 1, wherein the step of obtaining biologic feature information of a user, comprises:
obtaining voice recognition information of the user;
the step of authenticating the biologic feature information of the user, when the biologic feature information passes authentication, reminding the user a third application is allowed to use, comprises:
comparing the voice recognition information with pre-stored voice recognition information, when the voice recognition information matches with the pre-stored voice recognition information, reminding the user the third application is allowed to use.

9. A third application login apparatus, comprising:
an obtaining module, configured to obtain biologic feature information of a user;
an authenticating and prompting module, configured to authenticate the biologic feature information of the user obtained by the obtaining module, when the biologic feature information passes an authentication, the authenticating and prompting module further configured to remind the user the third application is allowed to use.
a detecting module, configured to detect a rigger instruction generated according to a user's response to a reminder input by any third application via the authenticating and prompting module;
a receiving and sending module, configured to respond to the trigger instruction detected by the detecting module, and send an information obtaining request to a cloud server, the information obtaining request being configured to obtain a personal account of the third application, and receive the personal account of the third application sent from the cloud server; and
a logging in module, configured to login the third application with the personal account of the third application received by the receiving and sending module.

10. The third application login apparatus according to claim 9, wherein the information obtaining request comprises an identification of the third application.

11. The third application login apparatus according to claim 10, wherein the receiving and sending module is further configured to receive the personal account of the third application input by the user, and send the personal account of the third application and the identification of the third application to the cloud server; when the personal account of the third application passes an authentication, the receiving and sending module is further configured to store a mapping relationship between the identification of the third application and the personal account of the third application.

12. The third application login apparatus according to claim 9, wherein the information obtaining request comprises an identification of the third application and the biologic feature information of the user.

13. The third application login apparatus according to claim 12, wherein the receiving and sending module is further configured to receive the biologic feature information and the personal account input by the user, send the biologic feature information of the user, the personal account of the third application, and the identification of the third application to the cloud server; when the personal account of the third application passes an authentication, the receiving and sending module is further configured to store a mapping relationship among the biologic information of the user, the identification of the third application, and the personal account of the third application.

14. The third application login apparatus according to claim 9, wherein the obtaining module is configured to obtain figureprint recognition information of the user;
the authenticating and prompting module is configured to compare the figureprint recognition information of the user with pre-stored figureprint recognition information; when the figureprint recognition information of the user matches with the pre-stored figureprint recognition information, the authenticating and prompting module is configured to remind the user the third application is allowed to use.

15. The third application login apparatus according to claim 9, wherein the obtaining module is configured to obtain facial recognition information;
the authenticating and prompting module is configured to compare the facial recognition information with pre-stored facial recognition information; when the facial recognition information matches with the pre-stored facial recognition information, the authenticating and prompting module is configured to remind the user the third application is allowed to use.

16. The third application login apparatus according to claim 9, wherein the obtaining module is configured to obtain voice recognition information;
the authenticating and prompting module is configured to compare the voice recognition information with pre-stored voice recognition information; when the voice recognition information matches with the pre-stored voice recognition information, the authenticating and prompting module is configured to remind the user the third application is allowed to use.

17. A third application login terminal, wherein the third application login terminal comprises a third application login apparatus, the third application login apparatus comprises:
an obtaining module, configured to obtain biologic feature information of a user;
an authenticating and prompting module, configured to authenticate the biologic feature information of the user obtained by the obtaining module, when the biologic feature information passes an authentication, the authenticating and prompting module further configured to remind the user the third application is allowed to use.
a detecting module, configured to detect a rigger instruction generated according to a user's response to a reminder input by any third application via the authenticating and prompting module;
a receiving and sending module, configured to respond to the trigger instruction detected by the detecting module, and send an information obtaining request to a cloud server, the information obtaining request being configured to obtain a personal account of the third application, and receive the personal account of the third application sent from the cloud server; and
a logging in module, configured to login the third application with the personal account of the third application received by the receiving and sending module.

18. The third application login terminal according to claim 17, wherein the obtaining module is configured to obtain figureprint recognition information of the user;
the authenticating and prompting module is configured to compare the figureprint recognition information of the user with pre-stored figureprint recognition information; when the figureprint recognition information of the user matches with the pre-stored figureprint recognition information, the authenticating and prompting module is configured to remind the user the third application is allowed to use.

19. The third application login terminal according to claim 17, wherein the obtaining module is configured to obtain facial recognition information;
the authenticating and prompting module is configured to compare the facial recognition information with pre-stored facial recognition information; when the facial recognition information matches with the pre-stored facial recognition information, the authenticating and prompting module is configured to remind the user the third application is allowed to use.

20. The third application login terminal according to claim 17, wherein the obtaining module is configured to obtain voice recognition information;
the authenticating and prompting module is configured to compare the voice recognition information with pre-stored voice recognition information; when the voice recognition information matches with the pre-stored voice recognition information, the authenticating and prompting module is configured to remind the user the third application is allowed to use.
